(19) United States
(12) Patent Application Publication
(10) Pub. No.: US 2005/0286856 A1
(43) Pub. Date: Dec. 29, 2005

(54) Portable media player with adaptive playback buffer control

(75) Inventor: Steven G. E. Aerts, Leuven (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,839

(22) PCT Filed: Dec. 2, 2003
(86) PCT No.: PCT/IB03/05566

§ 371 Date: May 31, 2005

(30) Foreign Application Priority Data
Dec. 4, 2002 (EP) 02080050.4

(51) Int. Cl. H04N 5/76; H04N 5/781

(52) U.S. Cl. 386/46; 386/125

(57) ABSTRACT

The invention relates to a portable content presentation device (101) such as a portable audio player. The portable presentation device (101) comprises a content signal source (103) for providing a first content signal. A memory (111) buffers content signal to provide electronic shock protection. The portable presentation device (101) comprises a presentation signal generator (105) which generates a suitable presentation signal. The portable presentation device (101) also comprises a memory controller (113) which dynamically adjusts the buffer memory allocation and creates a second memory allocation of the memory (111) for a second application. A portability processor (123) determines a portability state, e.g. indicating stationary or portable use, and the memory allocation is in response thereto, such that the buffer memory is reallocated to the second application, when the portable presentation device (101) is used in a stationary mode. The second application may be a second presentation application such as a presentation application for images.

The invention relates to a portable content presentation device and method of presenting content therefor and in particular to a portable audio player capable of performing a second application.

In recent years, the quantity and variety of consumer electronic products have increased dramatically. To a large extent this increase has been associated with increased availability and use of digital source encoding and distribution for a number of different content types that were previously encoded and distributed in analogue form. These content types include audio signals and video signals.

For example, video signals and TV broadcasts are traditionally transmitted as analogue signals. However, digital encoding is increasingly used and specifically TV broadcasts using digital MPEG 2 encoding are gradually becoming more prevalent than analogue transmission. Likewise, audio signals are typically encoded in analogue form for radio broadcasts but in the last decade digital radio broadcast transmissions have been made available, for example through the standardisation of a broadcast standard such as the Digital Audio Broadcast (DAB) standard.

In the field of storage media based audio content distribution, digital source encoding and distribution has become commonplace over the last couple of decades. A well-known example is the Compact Disc (CD), where audio signals are stored as digital sample values of the original audio signal. In latter years, this trend has continued by a number of digital compression techniques being developed to allow for reduced storage and distribution bandwidth requirements. An example is the well-known compression standard MP3, which significantly reduces the required data size for encoding an audio signal in comparison to for example CDs.

In another field, digital photo cameras have become generally available and are close to achieving higher sales numbers than conventional film based cameras. This has resulted in new devices being developed capable of storing, processing and displaying digital pictures.

The advent of many different digitally encoded signals has resulted in a convergence of devices and applications associated with different content signals. For example, storage media such as recordable CDs or memory cards may be used with many different content signals including for example digitally encoded music or digital pictures. Furthermore, there is currently a trend towards merging different functionality into single devices. In addition, there is a trend towards increasing functionality and capabilities of portable devices. This trend is to a large extent driven by the opportunities provided by the digital representation of content signals and the therewith associated digital processing.

For example, traditionally portable music players such as CD players typically comprise a small built in display for providing information and facilitating navigation. However, devices are emerging which are capable of both audio and video content presentation. In this case the video display unit may additionally be used for information and navigation of the audio content. The video display unit may for example be an external TV.

For example, many portable CD players are currently capable of decoding MP3 encoded audio signals. As another example, most digital cameras provide video recording facilities and most digital camcorders provide some digital photography function. As a third example, many mobile phones provide the additional capability of decoding and playing MP3 encoded signals.

However, typically, the combination of different and possibly incompatible functions increases the requirements of a device and especially increases the computational and memory requirements. Hence, additional processing power and memory must typically be included thereby substantially increasing the cost of the device. Especially, for content presentation devices, the additional memory resources are typically very substantial and have a significant associated cost impact.

Hence, an improved content presentation system would be advantageous and in particular an improved content presentation system which allows for an improved performance of applications and/or improved memory efficiency would be advantageous.

Accordingly, the Invention seeks to mitigate, alleviate or eliminate one or more of the above mentioned disadvantages singly or in any combination.

According to a first aspect of the invention, there is provided a portable content presentation device comprising: a content signal source for providing a first content signal; a memory; a presentation signal generator operable to generate a presentation signal from the first content signal; a portability processor for determining a portability state of the portable content presentation device; and a memory controller operable to dynamically adjust a first memory allocation of the memory associated with the first content signal and to create a second memory allocation of the memory for a second application in response to the portability state.

The content presentation device may for example be a portable CD player, DVD player, MP3 player or digital radio. The presentation signal may for example be an audio signal or a visual signal. The content signal source may be an internal content source such as a CD drive or may be interface means operable to receive a content signal from an external source. The memory controller may for example adjust the first memory allocation and create the second memory allocation by dividing the available memory into a first memory allocation and a second memory allocation. A given memory partition may for example be allocated as a buffer memory allocation or as a second memory allocation in response to a given characteristic or occurrence. Specifically, the memory controller may switch between allocating the entire memory as the first memory allocation or as the second memory allocation. Alternatively, the memory may be partitioned efficiently between concurrent applications.

Accordingly, the invention allows for an improved portable content presentation device, which has an improved memory efficiency. In particular, memory associated with the first content signal may be reused as memory for a second application. Hence, the performance of the second application may for example be improved or enabled by this memory allocation. The total memory requirement of a portable content presentation device capable of performing a second application may be reduced. Especially a content presentation device having multiple functions and capabilities thus benefits from an improved dynamic memory allocation. Available memory may specifically be shared or allocated according to current requirements and needs. Increasing memory availability may typically increase speed of processing. Thus, the invention tends to provide a content presentation device having improved memory efficiency, reduced cost, increased flexibility, reduced complexity and or increased processing speed.

Specifically, the requirement for memory associated with the first content signal, for example buffer memory, may often be associated with the current portability characteristics of the portable presentation device and by allocating buffer memory in response to a portability state an improved memory allocation can be achieved. Specifically, the buffer memory allocation may be determined so as to achieve acceptable performance for the current portability state, and specifically the buffer memory allocation may increase for increasing movement. In this case, the second memory allocation will tend to be maximised while the impact on the performance is negligible. The portability state may for example be determined from a user input.

According to a feature of the invention, the first memory allocation is a buffer memory allocation for the first content signal. This allows for buffering in a portable state while allowing the memory to be reused when buffering is not needed in a stationary state.

According to another feature of the invention, the first memory allocation is electronic shock protection memory, and the portable content presentation device comprises a shock protection processor operable to control the buffering of the first content signal in the memory so as to reduce fluctuations in a content signal buffer output rate. Hence, the invention allows for the electronic shock protection memory of a portable device to be used by a second application. This may improve the performance of the application. Specifically, the complete memory, or a part of it, may be allocated to the second application when no or less shock protection memory is necessary for acceptable performance of the content presentation of the content signal. Hence, the performance of the portable presentation device may be improved. Alternatively or additionally, the memory requirements of the portable presentation device may be reduced thus resulting in lower cost.

According to another feature of the invention, the portability state comprises a portability state indication of whether the portable content presentation device is in a substantially stationary state or in a substantially portable state. This allows for a simple and reliable portability state detection while ensuring advantageous memory allocation and good performance. The buffer memory requirements are typically low or non-existent for a stationary use but high for a non-stationary use. For example, for electronic shock protection memory, substantially all of the memory may typically be allocated to the second memory allocation for stationary use. However, for non stationary use, substantially all of the memory may be allocated for the buffer memory allocation.

According to another feature of the invention, the portability processor is operable to set the portability state indication in response to a movement detection. The movement detection may be a direct detection, for example by a dedicated movement detector, or may be indirect, for example through the detection of interruptions in the content signal from the content signal source. This feature allows for a suitable and advantageous implementation for detection of a portability state indication.

According to another feature of the invention, the portability processor is operable to set the portability state indication in response to a detection of the portable content presentation device having an external connection. An external connection may for example be a connection to external presentation means. The detection of a connection may be by detection of a signal, characteristic or indication associated with an external device. Alternatively or additionally, the detection may be by a physical detection for example by detecting that a connector has been attached to the portable presentation device. A very reliable, simple and easy to implement means of determining a portability state indication may thus be provided.

According to another feature of the invention, the external connection is an external connection to a substantially stationary presentation device. Depending on the content signal and/or the second application, the device may for example be an external monitor such a as a TV, an audio amplifier such as a HiFi device or a computer. An external connection to a substantially stationary presentation device provides a high likelihood of the portable presentation device being used in a stationary mode and thus the portability state indication may be set with high reliability.

According to another feature of the invention, the external connection is an external connection to a power source. An external power source may for example be detected by the external power being available or by a power connector being connected to the portable presentation device. The presence of an external power source provides a high probability of the portable presentation device being used in a stationary mode, and thus the portability state indication may be set with high reliability.

According to another feature of the invention, the second application is a control application of the portable content presentation device. The control application may for example be a user interface application such as a graphical user interface (GUI). The control application may specifically be associated with stationary operation such as an application predominantly used in stationary mode. For example, a GUI may only be provided when the portable presentation device is connected to an external monitor. Hence, the control application may be enabled or improved performance may be enabled by an allocation of buffer memory to the control application.

According to another feature of the invention, the content signal source is further operable to provide a second content signal and the second application is a processing function associated with the second content signal. Preferably, the second application is a presentation application of a second content signal. The portable presentation device may be capable of presenting different types of content signals. For example the portable presentation device may be capable of presenting an audio signal, such as an MP3 signal, as well as a simultaneous presentation of visual data, such as digital pictures. The content signal source may comprise a plurality of different sub content sources such as for example a memory card and a CD drive. Different functionality may thus be merged in the portable presentation device, and the available memory may be allocated dynamically between these. Specifically, the performance of the content presentation of the second application may be improved if the buffer memory is not required for the presentation of the content signal from the content signal source.

According to another feature of the invention, the second content signal is a different type of content signal than the first content signal. Preferably, the first content signal is an audio content signal and the second content signal is a visual content signal. The memory may be used to optimise the performance of presentation applications for different types of content signals.

According to another feature of the invention, the second application is an image presentation application and the portable content presentation device is operable to use the second memory allocation as an image cache. The use of the memory for both buffer memory and as an image cache may increase performance and/or reduce memory requirements as different benefits for the different content signals can be obtained from the same memory.

According to another feature of the invention, the second application is enabled by the creation of the second memory allocation. Specifically, the second application may be an application which is only available when the portable presentation device is stationary. This allows for additional applications to be provided without increasing memory requirements, as the applications are only provided when the memory is available.

According to another feature of the invention, the memory consists in a single memory element. This may allow for reduced cost and size of the portable presentation device as single memory elements tend to be cheaper and take up less space.

According to a second aspect of the invention, there is provided a method of presenting content, the method comprising: receiving a first content signal; buffering the first content signal in a memory; generating a presentation signal from the first content signal; and dynamically adjusting a buffer memory allocation of the memory for buffering of the content signal and a second memory allocation of the memory for a second application.

These and other aspects of the invention will be apparent from and elucidated with reference to the embodiment(s) described hereinafter.

An embodiment of the invention will be described, by way of example only, with reference to the drawings, in which

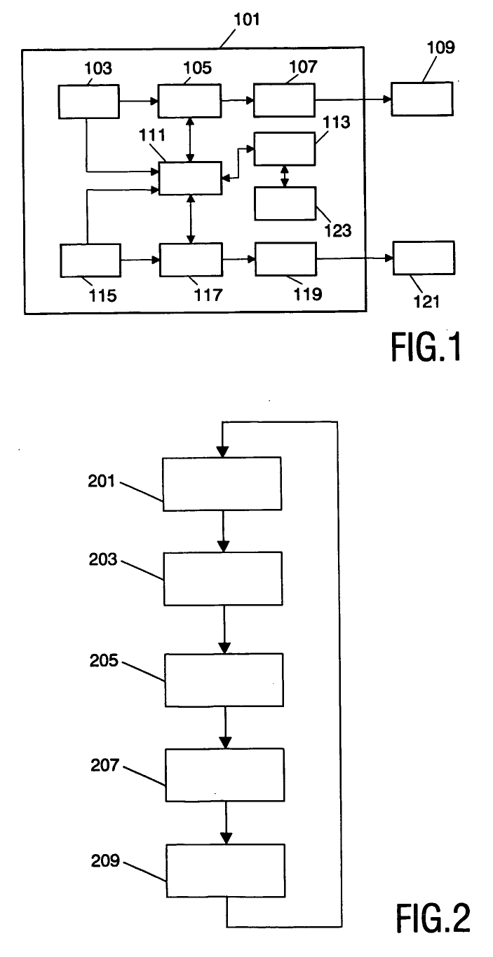

FIG. 1 is an illustration of a portable audio player in accordance with an embodiment of the invention; and

FIG. 2 is an illustration of a flowchart of a method of presenting content in accordance with an embodiment of the invention.

The following description focuses on an embodiment of the invention applicable to a portable audio player and in particular to a portable audio player additionally capable of presenting a second visual content type such as digital images. However, it will be appreciated that the invention is not limited to this application. The specific embodiment will focus on an embodiment wherein the first memory allocation is buffer memory and specifically electronic shock protection memory. However, it is within the contemplation of the invention that the first memory allocation may be used for any suitable application associated with the first content signal.

FIG. 1 is an illustration of a portable presentation device in accordance with an embodiment of the invention. In the described embodiment, the portable presentation device is a portable audio player 101 capable of playing an audio signal.

The portable audio player 101 comprises a content signal source 103 which in the preferred embodiment is a CD drive capable of retrieving data stored on a compact disc.

The content signal source 103 provides a data stream corresponding to the data read from the CD. The content signal may in the preferred embodiment typically be a normally PCM (Pulse Code Modulation) encoded signal, or may be an MP3 encoded signal, dependent on the CD that has been loaded in the portable audio player 101.

The content signal source 103 is connected to a presentation signal generator 105 which generates a presentation signal from the content signal received from the content signal source 103. In the preferred embodiment, the presentation signal generator 105 decodes the content signal and generates an analogue audio signal as is well-known in the art. Depending on the nature of the content signal the decoding may for example include PCM decoding or MP3 decoding.

The presentation signal generator 105 is connected to a first output element 107 which can be connected to a first external presentation device 109. In the preferred embodiment, the first output element 107 is an analogue audio amplifier which amplifies the analogue audio signal generated by the presentation signal generator 105 to a suitable level for the first external presentation device 109. The first external presentation device may specifically be headphones, speakers or an external amplifier or audio processing equipment.

The content signal source 103 is furthermore coupled to a memory 111. During operation, the content signal from the content signal source 103 may be fed to the memory 111 and buffered therein. In the preferred embodiment, the memory is capable of functioning as a FIFO (First In First Out) buffer wherein the data stream from the content signal source 103 is temporarily stored. An advantage of a FIFO buffer is that variations in the incoming data rate can be compensated, and the data can be read out at a substantially constant rate. Hence, the memory may function as electronic shock protection memory. In use, a portable CD drive tends to be susceptible to physical movement and shocks such that the content signal may be temporarily interrupted. Hence, the content signal from the content signal source 103 may exhibit significant variations which cause audible interruptions if not compensated. However, by buffering the signal in the memory 111, data can be read substantially continuously, and thereby interruptions in the audio output can be reduced. The larger the buffer memory the higher protection against shocks is achieved. In the embodiment of FIG. 1, the presentation signal generator 105 may receive the content signal directly from the content signal source 103 or via the memory buffer of the memory 111.

The portable audio player is furthermore capable of performing other applications than just playing the audio signal. In different embodiments, the portable audio player may for example be capable of presenting a video signal received from an external source, presenting a graphical user interface or performing source signal encoding functions. Accordingly, the portable audio player 101 comprises a memory controller 113 which is operable to allocate the memory 111 (or parts thereof) to different applications. Specifically, the memory controller 113 can dynamically adjust a first memory allocation of the memory 111 for buffering of the content signal whereby a second memory allocation may be created that can be used for the second application. In the preferred embodiment, the first memory allocation is a buffer memory allocation. Hence, the memory controller 113 can control the allocation of the memory 111 between the second application and the buffering of the content signal from the content signal source 103. The buffering and thus the shock protection may for example be traded off against the performance and memory requirements of the second application.

In the preferred embodiment, the second application is a second content presentation of a second content signal. The second content signal may be of a different type than the first content signal, and is in the preferred embodiment a content signal comprising digital images.

Accordingly, the portable audio player 101 of FIG. 2 further comprises a second content signal source 115. The second content signal source 115 may for example be a memory card comprising digital pictures from a digital camera. In some embodiments, the first and second content signal source 113, 115 may be the same content signal source. For example the CD drive of the first content signal source 113 may additionally be used to retrieve digital images stored on a CD such as for example a photo disc produced during development of conventional film based pictures.

The second content signal source 115 is connected to a second presentation signal generator 117, which generates a second presentation signal. In the preferred embodiment, the second presentation signal generator 117 generates a video signal comprising one or more of the images received from the second content signal source. Specifically, the second presentation signal generator 117 is operable to change the image contents of the video signal. In particular, the second presentation signal generator 117 may receive user inputs and select a specific image from the second content signal to be presented accordingly. The second presentation signal generator 117 is thus preferably operable to access the second content signal source 115 to retrieve the required content data.

The second presentation signal generator 117 is connected to a second output element 119 which is operable to interface the second presentation signal to a second presentation device 121. In the preferred embodiment, the second presentation device 121 is a video monitor or TV, and the second output element 119 is operable to amplify and modulate the video signal from the second presentation signal generator 117 such that it is suitable for the video monitor or TV.

Hence, in the preferred embodiment, the portable audio player 101 additionally provides a second application that enables a user to view digital images on a TV or video monitor. The user may select which picture to view, navigate through pictures, present a slide show and manipulate pictures. In the preferred embodiment, the different applications may further co-exist and be integrated with each other. Thus, for example, an MP3 encoded music sequence may be associated with a specific image, and when this image is selected, the associated music sequence may be played. The first and second presentation device 109, 121 may thus specifically be the same device.

The second content signal source 115 is furthermore connected to the memory 111, and in the preferred embodiment, the memory controller 113 is operable to control the memory 111 such that memory is allocated between the two applications according to a given algorithm. Specifically, the memory 111 is in the preferred embodiment used as an image cache for the second application. Hence, the memory 111 allocated to the second application enables a faster access to the images and thus a faster performance. The performance of the second application thus tends to improve for increased memory allocation sizes.

In the preferred embodiment, the second application furthermore comprises presenting a Graphical User Interface (GUI) to a user. Hence, the second presentation signal generator 117 is additionally operable to generate a GUI signal for presentation on the second presentation device 121. The GUI may specifically be used to control the presentation of images. The GUI application may further use memory allocated to the second application.

In some embodiments, the second application may be a different representation of the first signal source, such as a GUI, an index of (audio) content, visual effects etc.

In the preferred embodiment, the memory allocation of the memory 111 of the portable audio player 101 is allocated in response to a portability state of the portable audio player 101. For example, in the preferred embodiment the requirement for electronic shock protection is highest when the portable audio player 101 is used as a portable device. However, the second application of image presentation is associated with an external and typically stationary presentation device 121, and therefore tends to be used in a stationary situation. Hence, the memory 111 may be allocated such that in a state of portability, the memory allocation for the buffering of the audio content signal is high, and in a state of stationary use, the memory allocation for the second application may be high. Specifically, the entire available memory may be allocated to the audio signal presentation when in a portable state and to the second application when in a stationary state.

Accordingly, the portable audio player 101 comprises a portability processor 123 which is operable to determine a portability state of the portable audio player 101. The portability processor 123 is connected to the memory controller 113 which controls the memory allocation of the memory 111 according to the portability state determined. In the preferred embodiment, the memory allocation may further be in response to a user input thereby allowing a user to adjust the performance of the different applications. This may be particularly beneficial in situations where the portability processor 123 determines a portability state which is not consistent with the actual current use of the portable audio player 101.

The portability processor 123 may determine the portability state according to any suitable algorithm or criteria. For example, the portable audio player 101 may comprise a movement detector which is capable of detecting that the portable audio player 101 is being moved. Such a movement detector may for example comprise a small mechanical vibration sensor, wherein a moveable member forms an electrical connection if vibrations exceed a given level.

However, in the preferred embodiment, the portability state is determined in response to a detection of the portable audio player 101 having an external connection. For example, in the described embodiment, the second application requires a connection to an external presentation device 121. Thus, if the portable audio player 101 is connected to the second presentation device 121, the second application is likely to be used and thus a memory allocation may preferably be provided. Furthermore, the portable audio player 101 is likely to be used in a stationary mode as the external presentation device is stationary. Hence, by detecting if the portable audio player 101 is connected to an external device 121, the memory allocation of the memory 111 may be optimised, thereby allowing for increased performance of the different applications of the portable audio player 101 and optimising the memory use. Accordingly, a reduced total amount of memory is required as the available memory is effectively shared. Consequently, the cost of the portable audio player 101 may be reduced and/or the performance improved.

The detection of the portable audio player 101 being connected to an external presentation device may in the preferred embodiment be by detection of a signal characteristic of the external device. For example, the presence of a voltage on a connector input may be detected, thereby indicating that the external device is connected. Alternatively or additionally, the detection of the external connection may simply be by a mechanical detection that a connector has been coupled to the portable audio player 101. Thus the portable audio player 101 preferably comprises a socket for receiving a connecting cable to the presentation device 121. The socket includes a mechanical switch, which is triggered when the connecting cable is inserted into the socket. In this embodiment, the portability processor 123 is operable to set a portability indication to stationary when the mechanical switch is triggered and to portable (non-stationary) otherwise.

As another example, the detection of the portable audio player 101 being connected to an external presentation device may be by detection of an external load on an output of the device. For example, a monitor may be detected as an external load on a video connector. The load may for example be detected by measuring the current drawn from the video output.

Alternatively or additionally, the portability processor 123 may be operable to detect if the portable audio player 101 is connected to an external power source. If the portable audio player 101 is connected to an external power source this power source may be a mains adapter thus indicating that the portable audio player 101 is connected to the mains and consequently operated in a substantially stationary mode. The detection may be by detection of a mechanical insertion of a power connector in the portable audio player 101 or may be by detection of a signal associated with the external power source. This signal may simply consist in the supply voltage or may be an identification signal specifically indicating that the external power source is a substantially static power source.

In some embodiments, the second memory allocation provides an improved performance of the second application. However, in other embodiments, the second memory allocation is required for the second application to be performed. Hence, the second application may specifically be designed to rely on the presence of the second memory allocation. Specifically, applications which can only be used in a stationary mode may be implemented without any additional requirements being put on the memory size of the device.

FIG. 2 is an illustration of a flowchart of a method of presenting content in accordance with an embodiment of the invention. The method will be described with reference to the portable audio player 101 of FIG. 1.

In step 201, the portable audio player 101 receives a first content signal from a content source. The content source may be the first content source 103 or may be an external content source. In step 203, which follows step 201, the content signal is buffered in the memory 111. Step 203 is followed by step 205, wherein the presentation signal generator 105 generates a presentation signal from the first content signal. The presentation signal is presented on an external presentation device 109. In step 207 the memory controller 113 dynamically adjusts the buffer memory allocation of the memory 111 for buffering of the content signal and of a second memory allocation for a second application. Step 207 is followed by step 209 wherein the second application is processed. The method subsequently repeats in step 201.

The invention can be implemented in any suitable form including hardware, software, firmware or any combination of these. However, preferably, the invention is implemented as software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

It will be appreciated that the invention tends to provide one or more of the following advantages singly or in any permutation or combination:
It improves performance of and/or enables a plurality of applications.
It reduces memory requirements thus reducing cost.
It allows for optimized memory performance for a given portability state.

These and other advantageous will be apparent from the above description.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

The invention relates to a portable content presentation device (101) such as a portable audio player. The portable presentation device (101) comprises a content signal source (103) for providing a first content signal. A memory (111) buffers content signal to provide electronic shock protection. The portable presentation device (101) comprises a presentation signal generator (105) which generates a suitable presentation signal. The portable presentation device (101) also comprises a memory controller (113) which dynamically adjusts the buffer memory allocation and creates a second memory allocation of the memory (111) for a second application. A portability processor (123) determines a portability state, e.g. indicating stationary or portable use, and the memory allocation is in response thereto, such that the buffer memory is reallocated to the second application, when the portable presentation device (101) is used in a stationary mode. The second application may be a second presentation application such as a presentation application for images.

1. A portable content presentation device comprising:
a content signal source for providing a first content signal;
a memory;
a presentation signal generator operable to generate a presentation signal from the first content signal;
a portability processor for determining a portability state of the portable content presentation device; and
a memory controller operable to dynamically adjust a first memory allocation of the memory associated with the first content signal and to create a second memory allocation of the memory for a second application in response to the portability state.

2. A portable content presentation device as claimed in claim 1 wherein the first memory allocation is a buffer memory allocation for the first content signal.

3. A portable content presentation device as claimed in claim 2 wherein the first memory allocation is electronic shock protection memory and the portable content presentation device comprises a shock protection processor operable to control the buffering of the first content signal in the memory so as to reduce fluctuations in a content signal buffer output rate.

4. A portable content presentation device as claimed in claim 1 wherein the portability state comprises a portability state indication of whether the portable content presentation device is in a substantially stationary state or in a substantially portable state.

5. A portable content presentation device as claimed in claim 4 wherein the portability processor is operable to set the portability state indication in response to a movement detection.

6. A portable content presentation device as claimed in claim 4 wherein the portability processor is operable to set the portability state indication in response to a detection of the portable content presentation device having an external connection.

7. A portable content presentation device as claimed in claim 6 wherein the external connection is an external connection to a substantially stationary presentation device.

8. A portable content presentation device as claimed in claim 6 wherein the external connection is an external connection to a power source.

9. A portable content presentation device as claimed in claim 1 wherein the second application is a control application of the portable content presentation device.

10. A portable content presentation device as claimed in claim 1 wherein the content source is further operable to provide a second content signal and wherein the second application is a processing function associated with the second content signal.

11. A portable content presentation device as claimed in claim 1 wherein the second application is a presentation application of a second content signal.

12. A portable content presentation device as claimed in claim 11 wherein the second content signal is a different type of content signal than the first content signal.

13. A portable content presentation device as claimed in claim 12 wherein the first content signal is an audio content signal and the second content signal is a visual content signal.

14. A portable content presentation device as claimed in claim 13 wherein the second application is an image presentation application and the portable content presentation device (101) is operable to use the second memory allocation as an image cache.

15. A portable content presentation device as claimed in claim 1 wherein the second application is enabled by the creation of the second memory allocation.

16. A portable content presentation device as claimed in claim 1 wherein the portable content presentation device is a portable audio player.

17. A portable content presentation device as claimed in claim 1 wherein the memory consists in single memory element.

18. A method of presenting content, the method comprising:
receiving a first content signal;
determining a portability state of the portable content presentation device
generating a presentation signal from the first content signal; and
dynamically adjusting a first memory allocation of the memory associated with the first content signal and a second memory allocation of the memory for a second application.

19. A computer program enabling the carrying out of a method according to claim 18.

20. A record carrier comprising a computer program as claimed in claim 19.
